(19) United States
(12) Patent Application Publication
(10) Pub. No.: US 2017/0200518 A1
(43) Pub. Date: Jul. 13, 2017

(54) COMPOSITION FOR RADIATION SHIELDING AND METHOD FOR PREPARING SAME

(71) Applicant: RSMTECH CO., LTD., Buk-gu Daegu (KR)

(72) Inventors: Yong Joo YANG, Suseong-gu Daegu (KR); Gi Woung JEONG, Buk-gu Daegu (KR)

(73) Assignee: RSMTECH CO., LTD., Buk-gu Daegu (KR)

(21) Appl. No.: 15/314,274

(22) PCT Filed: Jul. 18, 2014
(86) PCT No.: PCT/KR2014/006526

§ 371 Date: Nov. 28, 2016

(30) Foreign Application Priority Data
Jun. 23, 2014 (KR) 10-2014-0076627

(51) Int. Cl. G21F 1/12; B32B 27/12; B32B 27/18; B32B 27/32; B32B 27/28; C08L 75/04; B32B 37/12; B29D 7/00; B32B 37/15; B32B 27/40; B32B 27/30; C08J 5/18; G21F 3/00; B32B 5/02

(52) U.S. Cl. CPC G21F 1/125; G21F 3/00; B32B 27/12; B32B 27/18; B32B 27/32; B32B 27/285; B32B 27/288; B32B 5/024; B32B 37/12; B29D 7/00; B32B 37/15; B32B 27/40; B32B 27/283; B32B 27/308; C08J 5/18; C08L 75/04; B29K 2995/0011; G21Y 2002/10; G21Y 2002/301; G21Y 2002/501; G21Y 2004/10; B32B 2255/10; B32B 2255/26; B32B 2262/0276; B32B 2305/188; B32B 2305/30; B32B 2305/77; B32B 2307/70; B32B 2367/00; B32B 2383/00; B32B 2571/00; B29L 2031/768

(57) ABSTRACT

Embodiments of the invention provide a composition for shielding radiation, including 100 parts by weight of a first resin including one or more selected from the group consisting of a polyurethane resin, a polysiloxane resin, a silicone resin; a fluorine resin, an acrylic resin, and an alkyd resin; 5 to 30 parts by weight of a second resin including one or more selected from the group consisting of polyvinyl alcohol (PVA), medium-density polyethylene (MDP E), high-density polyethylene (HDPE), and low-density polyethylene (LDPE); 5 to 30 parts by weight of a polyether ether ketone (PEEK) resin powder; 5 to 80 parts by weight of a metal powder; 1 to 70 parts by weight of a metal oxide powder; 1 to 50 parts by weight of paraffin; 5 to 15 parts by weight of a boron compound; and 10 to 50 parts by weight of a carbon powder. Accordingly, a fiber complex, protective clothing, and the like including the composition for shielding radiation of the present invention includes a PEEK resin without use of lead, and thus, may shield even neutron rays as well as radiation, such as alpha rays, beta rays, proton rays, gamma rays, and X-rays.

### CROSS REFERENCE TO RELATED APPLICATIONS:

This application claims the benefit of and priority to PCT/KR2014/006526, filed on Jul. 18, 2014, entitled (translation), “COMPOSITION FOR RADIATION SHIELDING AND METHOD FOR PREPARING SAME,” which claims the benefit of and priority to Korean Patent Application No. 10-2014-0076627, filed on Jun. 23, 2014, each of which are hereby incorporated by reference in their entirety into this application.

### BACKGROUND:

Field of the Invention:

Embodiments of the invention relate to a composition for shielding radiation and a method of preparing the same, more particularly to a composition for shielding radiation which may shield even neutron rays as well as radiation, such as alpha rays, beta rays, proton rays, gamma rays, and X-rays, without use of lead, a sheet manufactured using the composition, a textile complex for shielding radiation, and a method of preparing the same.

Description of the Related Art:

Radiation has existed since the universe began, and we are now living in an environment full of radiation. Radioactive materials exist in nature and some have been artificially produced for industrial or medical purposes. A type of such radioactive materials is various.

Ionizing radiation refers to radiation, such as alpha rays, beta rays, proton rays, neutron rays, gamma rays, and X-rays, causing ionization. Since alpha rays can be blocked by a paper-thin material and are instantly stopped in the air, shielding for such alpha rays is not specifically required. Although beta rays have greater energy than alpha rays, beta rays can generally be blocked with thin aluminum foil or a plastic plate.

On the other hand, gamma rays, which are generated by collapse or transformation of nuclei, are electromagnetic waves having energy greater than X-rays and have very strong transmittance. Such gamma rays can be blocked by concrete or a metallic material such as iron or lead. However, when a metallic material is used to block gamma rays, the weight of a shielding material disadvantageously increases due to a high density of the metallic material.

Neutron rays, which are generated when nuclei collapse or are divided, do not have charge. However, since high-speed neutron rays have a high energy of 1 MeV or more, a material containing a large amount of hydrogen atoms having a mass similar to neutrons is used to reduce the speed of high-speed neutron rays. A shielding material including a material for absorbing neutron rays that may absorb thermal neutron rays having low energy in which the speed of high-speed neutrons have been reduced is required.

In particular, gamma rays or neutrons may directly affect atoms or molecules and thus may change major structures of DNA or proteins. In addition, when gamma rays or neutron rays act on reproductive cells of organisms, mutations may be induced and thus the probability of causing deformity may increase. Further, when gamma rays or neutron rays act on the human body, diseases such as cancer may occur. Furthermore, thermal neutron rays radioactively pollute surrounding environments by irradiating surrounding materials. Accordingly, in fields to which radiation is applied, a material for shielding radiation to shield gamma rays or neutron rays harmful to the human body and the environment is required. With regard to this, gamma rays can be shielded using a material including iron, lead, cement, etc.

In addition, a material for shielding neutron rays can be prepared by mixing a compound, in which the content of hydrogen (H), oxygen (O), carbon (C), etc. having a similar mass is high and which includes a material, such as paraffin, carbon, boron, lithium, gadolinium, etc., having superior neutron ray absorption and a large thermal neutron absorption cross-section, with a polymer or a metallic base.

X-rays discovered by Roentgen are currently being used in various industrial and medical fields. Medical doctors, photographers operating x-ray inspection equipment, and practitioners working in schools, research institutes, and nuclear power plants can be continuously exposed to radiation due to the nature of their work.

When the human body is exposed to such harmful radiation for prolonged periods, DNA and chromosomes of the human body may be damaged. Accordingly, occurrence rates of cancers, such as leukemia, are high and the probabilities of fetal deformities, various other diseases, etc. are considerably high. As such, since exposure to radiation is harmful to the human body, practitioners working in fields related thereto should always wear a material for shielding radiation.

A conventional lead robe worn as protective clothing for shielding radiation has been manufactured by dispersing a lead ingredient in a mixture of a polyvinyl chloride resin (PVC) and a rubber ingredient and then laminating the dispersed mixture onto a sheet shape through extrusion. However, since the weight of such a lead robe is about 5 kg to 10 kg and thus too large, wearability and activity are very poor. Accordingly, such a lead robe is hardly used.

Swedish Patent No. 349366 (granted in 1960) discloses a method of artificially introducing barium sulfate to a conventional fiber for shielding radiation. However, since a sufficient amount of barium sulfate that can be added during polymer synthesis is very small, sufficient shielding effect is not exhibited. In addition, durability of the fiber is rapidly reduced. In the case of U.S. Pat. No. 3,239,669, lead is used and thus there is a disadvantage such as harmfulness to the human body. U.S. Pat. No. 3,192,439 discloses a method of manufacturing a wire, which is made of an alloy, in a fiber shape, so as to absorb X-rays. This method has a disadvantage in that the flexibility of a fiber is poor. Russian Patent No. 10-2000-7003445 discloses a method of preparing a mixture by dispersing metal particles and binding the prepared mixture to the surface of a fiber. In the case of this method, shielding effect may be exhibited, but it is difficult to exhibit durability by the method of binding the mixture to the fiber surface.

Japanese Translation of PCT International Application Publication No. 2008-538136 discloses a technology of using tungsten, barium sulfate, or bismuth as a raw material of a material for radiation-shielding. Since such a technology has shielding effect on X-rays and gamma rays, it may be applied to a shielding material for medical use. However, since a material produced using this technology does not have neutron ray shielding effect, it is not suitable for application to a shielding material used in a nuclear power plant from which various types of radiation are generated.

Korean Patent Application Publication No. 10-2004-0093878 introduces a technology of manufacturing fiber for shielding radiation using barium sulfate or an organic iodine material. By using this technology, harmful effect on the human body due to use of lead can be resolved and weight reduction can be accomplished. However, the technology does not provide neutron ray shielding effect and, when barium sulfate per se is simply used, excellent shielding effect against gamma rays or X-rays cannot be accomplished. Korean Patent Application Publication No. 10-2010-0047510 introduces a technology of mixing a nanomaterial for shielding radiation with a polymer. In particular, a technology of using metal nanoparticles to increase the probability of interaction between particles and radiation is disclosed. Such a technology is advantageous in accomplishing weight reduction. However, since some lead ingredients are applied, it is harmful to the human body. In addition, since metal nanoparticles are used in an amount of up to about 20% based on a total amount of a polymer, dispersion effect is excellent, but, due to a high proportion of the polymer, pores are large. Accordingly, in consideration of high transmittance of radiation, shielding effect is not sufficient. In addition, use of a single material, i.e., boron oxide (B₂O₃), is not sufficient to shield neutron rays having a wide energy distribution. Further, the metal nanoparticles are too expensive to be applied to fiber.

Korean Utility Model No. 1988-0012950 discloses a method of manufacturing fiber for shielding radiation. Fiber manufactured by such a method has problems in terms of weight and harmful effect on the human body. Korean Patent Application No. 10-2006-0070088 introduces fiber for shielding manufactured by a wet-spinning method using barium sulfate (BaSO₄). When such fiber is manufactured into thread, the content of the fiber cannot be increased, and thus, shielding effect is limited. Korean Patent Application Nos. 10-2009-0010508, 10-2009-0010581, and 10-2009-0010642 and the like disclose technologies of using a polymer such as polyethylene or polyolefin. When such technologies are used, the density of hydrogen atoms is high and, due to mixing of paraffin, there are advantages in terms of neutron ray shielding effect. However, since there are disadvantages in terms of bonding strength with fiber, materials manufactured using these technologies do not have durability and thus are not suitable for application to protective clothing or fiber. In addition, due to application of an organic iodine material, shielding effect against gamma rays or X-rays is decreased. Korean Utility Model Publication No. 20-1999-0023705 discloses a method of using a porous absorber. Upon application of such a method, effect against particle radiation, such as alpha rays, is superior, but effect against other types of radiation is not sufficient. In addition, Korean Patent Application No. 10-2004-0048588 introduces a material for shielding radiation excluding lead. In this case, antimony trioxide (Sb₂O₃) and tin (Sn) powder are used. Such materials are as harmful to the human body as lead.

Although many patents regarding fiber for shielding radiation have been filed and registered, most thereof have a problem of harmfulness to the human body due to use of lead or insufficient effect against various radiation types.

### SUMMARY:

Embodiments of the invention have been made in view of the above problems, and it is one object of the invention to provide a composition for shielding radiation which may shield even neutron rays as well as radiation, such as alpha rays, beta rays, proton rays, gamma rays, and X-rays, by including a polyether ether ketone (PEEK) resin without use of lead, and a method of preparing the same.

Embodiments of the invention provide a composition for shielding radiation, including 100 parts by weight of a first resin including one or more selected from the group consisting of a polyurethane resin, a polysiloxane resin, a silicone resin, a fluorine resin, an acrylic resin, and an alkyd resin; 5 to 30 parts by weight of a second resin including one or more selected from the group consisting of polyvinyl alcohol (PVA), medium-density polyethylene (MDPE), high-density polyethylene (HDPE), and low-density polyethylene (LDPE); 5 to 30 parts by weight of a PEEK resin powder; 5 to 80 parts by weight of a metal powder; 1 to 70 parts by weight of a metal oxide powder; 1 to 50 parts by weight of paraffin; 5 to 15 parts by weight of a boron compound; and 10 to 50 parts by weight of a carbon powder.

According to at least one embodiment, the composition for shielding radiation may further include 1 to 80 parts by weight of an inorganic additive based on 100 parts by weight of the first resin.

According to at least one embodiment, the first resin may be a polyurethane resin.

According to at least one embodiment, the metal powder may include one or more selected from the group consisting of aluminum, titanium, zirconium, scandium, yttrium, cobalt, tantalum, molybdenum, and tungsten.

According to at least one embodiment, the metal oxide powder may include one or more selected from the group consisting of palladium oxide, iridium oxide, ruthenium oxide, osmium oxide, rhodium oxide, platinum oxide, iron oxide, nickel oxide, cobalt oxide, indium oxide, aluminum oxide, potassium oxide, titanium oxide, tungsten oxide, and magnesium oxide.

According to at least one embodiment, the inorganic additive may include one or more selected from the group consisting of calcium hydroxide, calcium carbonate, magnesium hydroxide, magnesium carbonate, barium chloride, and barium sulfate.

According to at least one embodiment, the boron compound may include one or more selected from the group consisting of boric acid, colemanite, zinc borate, boron carbide, boron nitride, and boron oxide.

According to at least one embodiment, the carbon powder may include one or more selected from the group consisting of fullerene, carbon nanofiber, and a carbon nanotube.

According to at least one embodiment, the composition for shielding radiation may further include 10 to 100 parts by weight of a hardener based on 100 parts by weight of the first resin.

According to another embodiment, there is provided a sheet for shielding radiation, including the composition for shielding radiation.

According to another embodiment, there is provided a textile complex for shielding radiation, including a textile; and the sheet for shielding radiation.

According to at least one embodiment, the textile may include any one of woven fabrics, knitted fabrics, and non-woven fabrics.

According to at least one embodiment, the textile may include any one selected from among polyester fiber, nylon fiber, and aramid fiber.

According to at least one embodiment, the textile complex for shielding radiation may further include an adhesive layer between the textile and the sheet for shielding radiation.

According to at least one embodiment, the textile complex for shielding radiation may be used in one or more of a bag, protective equipment, and protective clothing for shielding radiation.

According to another embodiment, there is provided a textile complex for shielding radiation, including a laminate manufactured by sequentially laminating a first textile; a first adhesive layer disposed on the first textile; a sheet for shielding radiation disposed on the first adhesive layer; a second adhesive layer disposed on the sheet for shielding radiation; and a second textile disposed on the second adhesive layer.

According to another embodiment, there is provided a method of manufacturing a textile complex for shielding radiation, the method including: a step of coating an interior of a side dam, which includes a release paper on a bottom surface thereof, with the composition for shielding radiation prepared according to the aforementioned method (step 1); a step of preparing a sheet for shielding radiation by drying the composition coated according to step 1 (step 2); and a step of manufacturing a textile complex for shielding radiation by attaching a textile to the sheet for shielding radiation (step 3).

### BRIEF DESCRIPTION OF DRAWINGS:

These and other features, aspects, and advantages of the invention are better understood with regard to the following Detailed Description, appended Claims, and accompanying Figure. It is to be noted, however, that the Figure illustrates only various embodiments of the invention and are therefore not to be considered limiting of the invention's scope as it may include other effective embodiments as well.

FIG. 1 illustrates a sectional view of a textile complex for shielding radiation according to an embodiment of the invention.

FIG. 2 illustrates a sectional view of another textile complex for shielding radiation according to an embodiment of the invention.

FIG. 3 schematically illustrates a coating system employing a side dam manner used to manufacture a sheet for shielding radiation according to an embodiment of the invention.

FIG. 4 schematically illustrates a side view of a sheet for shielding radiation which is manufactured through a coating system employing a side dam manner and side dams according to an embodiment of the invention. Here, a member number “10” indicates side dams, a member number “20” indicates a first release film, a member number “30” indicates a sheet for shielding radiation, and a member number “40” indicates a second release film.

FIG. 5 schematically illustrates the structures of side dams according to an embodiment of the invention. Here, a member number “10” indicates side dams and a member number “20” indicates a first release film.

### DETAILED DESCRIPTION:

Advantages and features of embodiments of the invention and methods of accomplishing the same will be apparent by referring to embodiments described below in detail in connection with the accompanying drawings. However, embodiments of the invention is not limited to the embodiments disclosed below and may be implemented in various different forms. The embodiments are provided only for completing the disclosure of the invention and for fully representing the scope of the embodiments of the invention to those skilled in the art.

For simplicity and clarity of illustration, the drawing figure illustrates the general manner of construction, and descriptions and details of well-known features and techniques may be omitted to avoid unnecessarily obscuring the discussion of the described embodiments of the invention. Additionally, elements in the drawing figure is not necessarily drawn to scale. For example, the dimensions of some of the elements in the figure may be exaggerated relative to other elements to help improve understanding of embodiments of the invention. Like reference numerals refer to like elements throughout the specification.

Embodiments of the invention will be described below, but the invention is not limited to the embodiments described below, and it should be understood that the scope of the invention includes various embodiments in which the embodiments described below are modified, improved, or changed as appropriate, based on the ordinary knowledge of those skilled in the art, within the scope not deviating from the spirit of the embodiments of the invention.

Embodiments of the invention provide a composition for shielding radiation.

According to at least one embodiment, the composition for shielding radiation includes 100 parts by weight of a first resin including one or more selected from the group consisting of a polyurethane resin, a polysiloxane resin, a silicone resin, a fluorine resin, an acrylic resin, and an alkyd resin; 5 to 30 parts by weight of a second resin including one or more selected from the group consisting of polyvinyl alcohol (PVA), medium-density polyethylene (MDPE), high-density polyethylene (HDPE), and low-density polyethylene (LDPE); 5 to 30 parts by weight of a PEEK resin powder; 5 to 80 parts by weight of a metal powder; 1 to 70 parts by weight of a metal oxide powder; 1 to 50 parts by weight of paraffin; 5 to 15 parts by weight of a boron compound; and 10 to 50 parts by weight of a carbon powder.

According to at least one embodiment, the specific gravity of the medium-density polyethylene may be 0.926 to 0.940, the specific gravity of the high-density polyethylene may be 0.941 or more, and the specific gravity of the low-density polyethylene may be 0.925 or less.

Preferably, the composition for shielding radiation may further include 1 to 80 parts by weight of an inorganic additive based on 100 parts by weight of the first resin.

According to at least one embodiment, the first resin is preferably a polyurethane resin. The polyurethane resin has superior bonding strength to a fiber material, superior durability, and excellent flexibility, and thus is suitable as a material for radiation-shielding. In addition, since the polyurethane resin has a high hydrogen density, it may effectively reduce high-speed neutron rays. In addition, the polyurethane resin has advantages such as superior bonding strength to a fiber material, high durability, and superior flexibility.

According to at least one embodiment, the second resin may enhance neutron ray shielding.

When the content of the second resin is less than 5 parts by weight based on 100 parts by weight of the first resin, neutron ray shielding effect may be decreased. When the content of the second resin is 30 parts by weight or more based on 100 parts by weight of the first resin, bonding strength to fiber may be decreased or, when being manufactured into a sheet, strength is decreased and thus it may be difficult to apply the same to a material for radiation-shielding.

As the metal powder, aluminum, titanium, zirconium, scandium, yttrium, cobalt, tantalum, molybdenum, tungsten, or the like may be used. However, embodiments of the invention are not limited thereto and a metal having a relatively large electron density may be used.

As the metal oxide powder, palladium oxide, iridium oxide, ruthenium oxide, osmium oxide, rhodium oxide, platinum oxide, iron oxide, nickel oxide, cobalt oxide, indium oxide, aluminum oxide, potassium oxide, titanium oxide, tungsten oxide, magnesium oxide, or the like may be used.

A complex of the metal powder and the metal oxide powder may be used, but the embodiments of the invention are not limited thereto.

According to at least one embodiment, the metal powder and the metal oxide powder respectively have a particle diameter of 0.01 to 100 μm.

As the inorganic additive, calcium hydroxide, calcium carbonate, magnesium hydroxide, magnesium carbonate, barium chloride, barium sulfate, or the like may be used. Such an inorganic additive is harmless to the human body and provides superior radiation-shielding effect. Accordingly, as the inorganic additive, a material having a high density is preferably used.

According to at least one embodiment, the inorganic additive preferably has a particle diameter of 0.01 to 100 μm.

According to at least one embodiment, the paraffin, a main component of which is a straight-chain paraffin hydrocarbon (CH₃(CH₂)ₙCH₃), has abundant carbon atoms therein and the boron compound has a micro-absorption cross section and a high and wide energy distribution. Accordingly, the paraffin and the boron compound are suitable for shielding of neutron rays. In shielding neutron rays, a material containing a large amount of light atoms, such as hydrogen, oxygen, carbon, etc. having a mass similar to neutrons, is preferred.

As the boron compound, boric acid (H₃BO₃), colemanite (Ca₂O₁₄B₆H₁₀), zinc borate (Zn₂O₁₄, 5H₇B₆, Zn₄O₈B₂H₂, and Zn₂O₁₁B₆), boron carbide (B₄C), boron nitride (BN) and boron oxide (B₂O₃), or the like may be used. More preferably, a composite material of zinc borate and boron carbide may be used.

As the carbon powder, fullerene, carbon nanofiber, a carbon nanotube, or the like may be used.

According to at least one embodiment, the particle diameter of the carbon powder is preferably 5 to 200 nm.

According to at least one embodiment, the composition for shielding radiation may further include 10 to 100 parts by weight of a hardener based on 100 parts by weight of the first resin.

In this case, the composition for shielding radiation is a two-component composition. When the first resin includes one or more of thermosetting resins, i.e., a polyurethane resin, a polysiloxane resin, a fluorine resin, and an alkyd resin, the hardener is preferably included.

As needed, a catalyst for facilitating hardening of the composition for shielding radiation may be additionally included.

A sheet for shielding radiation according to various embodiments of the invention includes the aforementioned composition for shielding radiation.

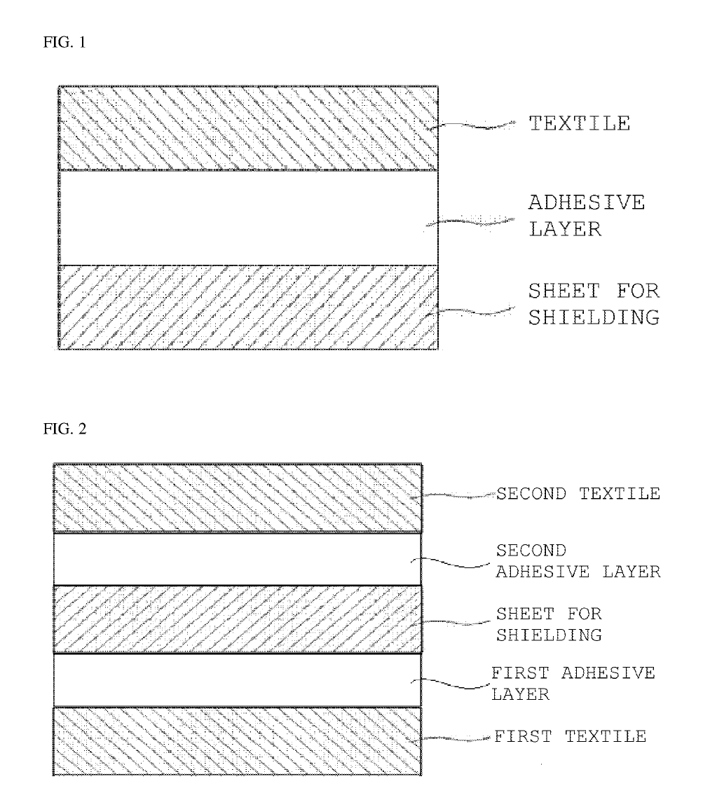

FIGS. 1 and 2 schematically illustrate a sectional view of a textile complex for shielding radiation according to embodiments of the invention. Hereinafter, the textile complex for shielding radiation according to various embodiments of the invention is described in detail with reference to FIGS. 1 and 2.

The textile complex for shielding radiation according to at least one embodiment may include a textile and the sheet for shielding radiation formed on the textile.

According to at least one embodiment, the textile may include woven fabrics, knitted fabrics, non-woven fabrics, etc.

In detail, an adhesive layer may be further included between the textile and the sheet for shielding radiation as illustrated in FIG. 1.

In particular, the textile complex for shielding radiation may be a laminate formed by sequentially laminating a textile; an adhesive layer disposed on the textile; and the sheet for shielding radiation disposed on the adhesive layer.

As needed, the textile complex for shielding radiation may be a laminate formed by sequentially laminating a first textile; a first adhesive layer disposed on the first textile; the sheet for shielding radiation disposed on the first adhesive layer; a second adhesive layer disposed on the sheet for shielding radiation; and a second textile disposed on the second adhesive layer, as illustrated in FIG. 2.

The textile may include polyester fiber, nylon fiber, aramid fiber, and the like, but the various embodiments of the invention are not limited thereto.

When the two-component composition including a hardener is used as described in the description of the composition for shielding radiation of the present invention, a separate adhesive layer provided for adhesion between the textile and the sheet for shielding radiation may be omitted. In particular, in a state in which the sheet for shielding radiation is semi-dried, the textile is bonded to the sheet and, by applying heat, is completely dried and bonded to the sheet, thereby being attached to the sheet.

The textile complex for shielding radiation may be applied to all textiles requiring radiation-shielding abilities, such as bags, protective equipment, and protective clothing for shielding radiation.

Hereinafter, a method of preparing the composition for shielding radiation according to various embodiments of the invention are described.

First, a first preliminary composition that includes 100 parts by weight of a first resin including one or more selected from the group consisting of a polyurethane resin, a polysiloxane resin, a silicone resin, a fluorine resin, an acrylic resin, and an alkyd resin; 5 to 30 parts by weight of a second resin including one or more selected from the group consisting of PVA, MDPE, HDPE, and LDPE; and 5 to 30 parts by weight of a PEEK resin powder is prepared (step a).

In addition, when one or more of isopropyl alcohol (IPA), methyl ethyl ketone (MEK), toluene, dimethyl formamide (DMF), and xylene is additionally included, dispersion and viscosity of the composition may be controlled. Accordingly, a process of forming a coating layer using a composition for shielding radiation and control of the thickness of the coating layer using the composition may be facilitated.

Subsequently, 5 to 80 parts by weight of a metal powder; 1 to 70 parts by weight of a metal oxide powder; 1 to 50 parts by weight of paraffin; 5 to 15 parts by weight of a boron compound; and 10 to 50 parts by weight of a carbon powder are added to the first preliminary composition, thereby preparing a composition for shielding radiation (step b).

In step b, 1 to 80 parts by weight of an inorganic additive may be additionally included based on 100 parts by weight of the first resin.

Here, the paraffin, the boron compound, and the carbon powder are preferably added and mixed after mixing the metal powder and the metal oxide powder with the first preliminary composition and then performing preliminary mixing.

Such preliminary mixing is performed to finally increase radiation-shielding effects of a coating layer consisting of the composition for shielding radiation of the present invention by allowing uniform dispersion.

Types of the inorganic additive, boron compound, and carbon powder are the same as those described above, and thus, detailed description thereof is omitted.

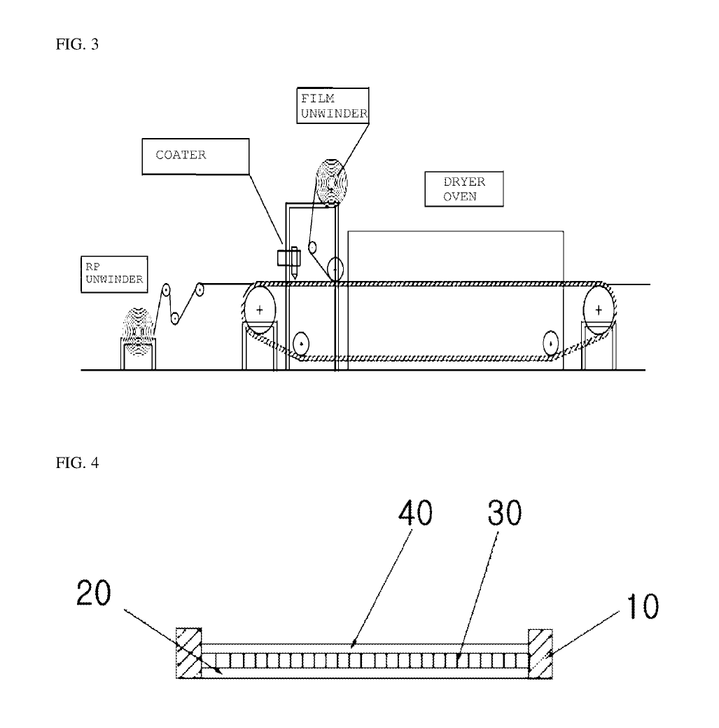

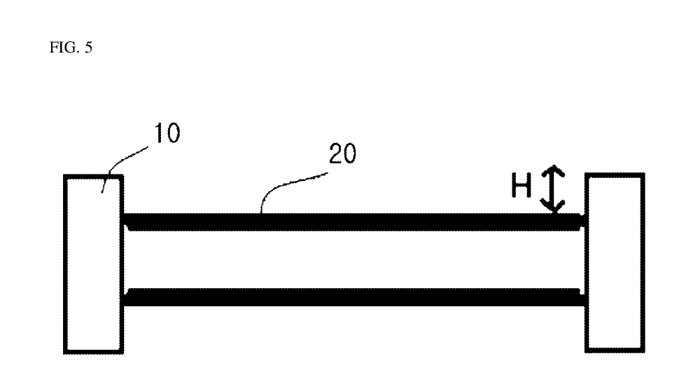

FIG. 3 schematically illustrates a coating system employing a side dam manner used to manufacture a sheet for shielding radiation according to an embodiment of the invention, and FIG. 4 schematically illustrates a side view of a sheet for shielding radiation which is manufactured through a coating system employing a side dam manner and side dams according to an embodiment of the invention. In addition, FIG. 5 is a sectional view schematically illustrating the structure of the side dam.

Referring to FIGS. 3 to 5, the sheet for shielding radiation is described in detail.

Hereinafter, a method of manufacturing a sheet for shielding radiation according to an embodiment of the invention is described.

First, an interior of a side dam apparatus 10 including a first release film 20 on a bottom surface thereof is coated with a composition for shielding radiation 30 prepared according to the preparation method to a predetermined thickness (step 1).

Coating with the composition for shielding radiation 30 is performed by means of a cylinder coater and thus a coating layer is formed to a predetermined thickness. A resultant coating layer preferably has a thickness of 20 μm to 4000 μm, but the thickness thereof may be properly controlled as needed.

According to at least one embodiment, the thickness of a formed composition coating layer may be controlled depending upon the height (H) of the side dam apparatus 10. In addition, the height (H) of the side dam apparatus 10 may be controlled by wrapping the bottom surface of the side dam apparatus 10 with the first release film 20 and thus controlling the height of the bottom surface. In other words, when the height of the bottom surface increases by wrapping the first release film 20 several times, the height (H) of the side dam apparatus 10 is relatively decreased, whereby a thin sheet for shielding radiation may be manufactured. On the other hand, when the number of times of wrapping with the first release film 20 is low or the bottom surface is merely formed without wrapping, the height of the bottom surface is lowered and the height (H) of the side dam apparatus 10 relatively increases, whereby a relatively thick sheet for shielding radiation may be manufactured.

Next, the composition 30 coated in step 1 is dried, thereby manufacturing a sheet for shielding radiation 30 (step 2).

According to at least one embodiment, the drying is preferably performed at 110 to 140° C. for 30 to 60 seconds, but the scope of the present invention is not limited. The drying temperature and time may be properly controlled depending upon the thickness or ingredients of the composition 30.

According to at least one embodiment, the second release film 40 may be attached onto the sheet for shielding radiation 30 and thus may protect the same.

Hereinafter, a method of manufacturing the textile complex for shielding radiation according to an embodiment of the invention is described.

First, a sheet for shielding radiation is manufactured according to the aforementioned method (steps 1 and 2).

Subsequently, a textile is attached to the sheet for shielding radiation, thereby manufacturing a textile complex for shielding radiation (step 3).

Before step 3, a step of forming an adhesive layer on one surface of the sheet for shielding radiation or the textile may be additionally included. In addition, after step 3, a step of drying and hardening the adhesive layer may be additionally included.

According to at least one embodiment, the adhesive layer may be formed to a uniform thickness by means of a comma knife, but a method of forming a uniform thickness is not limited thereto.

When the textile complex for shielding radiation manufactured according to the method is used to manufacture protective equipment, bags, and the like for shielding radiation, the textile complex for shielding radiation may be used in multiple layers used to increase shielding effect depending upon radiation intensity. As needed, an inner textile may be additionally included at a surface which a content emitting radiation contacts.

### EXAMPLES

Hereinafter, the configuration of the present invention is particularly described through the following examples, but the scope of the present invention is not limited thereto.

### Example 1

5 parts by weight of MDPE, as a polyethylene-based powder, 10 parts by weight of HDPE, and 5 parts by weight of a LDPE resin (manufactured by KUMHO PETROCHEMICAL) were mixed Based on 100 parts by weight of a polyurethane resin (manufactured by DONGSUNG CORPORATION, grade D-ACE 760).

Subsequently, 15 parts by weight of a PEEK, manufactured by VICTREX, grade 90p, a structural formula:

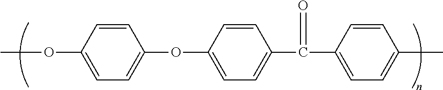

was mixed with the polyurethane resin 100 parts by weight, and then 20 parts by weight of MEK, 10 parts by weight of toluene, and 20 parts by weight of DMF were additionally added based on 100 parts by weight of the polyurethane resin. As a result, a first preliminary composition was prepared.

Preliminary mixing was performed by adding 4 parts by weigh of a molybdenum powder (manufactured by AOMETAL CO., LTD.), as a metal powder, 3 parts by weight of a tantalum powder (manufactured by AOMETAL CO., LTD.), 35 parts by weight of tungsten oxide (WO₃) powder (manufactured by AOMETAL CO., LTD.), as a metal oxide powder, and 5 parts by weight of barium sulfate (BaSO₄), as an inorganic additive (manufactured by SOLVAY) to the first preliminary composition.

Subsequently, 13 parts by weight of paraffin, 8 parts by weight of boron carbide (B₄C), and 25 parts by weight of carbon nanofiber (manufactured by Columbia Chemical, grade CD7097U) were added and mixed based on 100 parts by weight of a polyurethane resin, thereby preparing a solution including a composition for shielding radiation.

The solution including the composition for shielding radiation was coated to a thickness of 150 μm on a release film (or release paper) by means of a dam coater, thereby manufacturing a film for shielding radiation shield. Subsequently, drying and hardening were performed at 130° C. for 50 seconds. Subsequently, an adhesive was prepared by 100 parts by weight of a polyurethane adhesive resin (a two-component type, D-ACE 5038B manufactured by DONGSUNG CHEMICAL CO., LTD.), 10 parts by weight of a hardener (D-ACE575 manufactured by DONGSUNG CHEMICAL CO., LTD.), 20 parts by weight of DMF, and 20 parts by weight of MEK. A resultant adhesive was coated to a thickness of 50 μm on a surface layer of the film for shielding radiation by means of a comma knife. Woven fabric including polyester fiber was laminated on the adhesive and drying and hardening were performed at 130° C. for 50 seconds. As a result, a textile complex for shielding radiation was manufactured.

### Example 2

10 parts by weight of MDPE, as a polyethylene-based powder, 5 parts by weight of HDPE, and 5 parts by weight of a LDPE resin (manufactured by KUMHO PETROCHEMICAL) were mixed Based on 100 parts by weight of a polyurethane resin.

Subsequently, 30 parts by weight of a polyether ether ketone resin, which was the same as that used in Example 1, was mixed with the polyurethane resin 100 parts by weight, and then 20 parts by weight of MEK, 10 parts by weight of toluene, and 20 parts by weight of DMF were additionally added based on 100 parts by weight of the polyurethane resin. As a result, a first preliminary composition was prepared.

Preliminary mixing was performed by adding 10 parts by weigh of a molybdenum powder, as a metal powder, 10 parts by weight of a tantalum powder, 20 parts by weight of tungsten oxide (W0₃) powder, as a metal oxide powder, and 5 parts by weight of barium sulfate (BaSO₄), as an inorganic additive, to the first preliminary composition.

Subsequently, 25 parts by weight of paraffin, 5 parts by weight of boron carbide (B₄C), and 15 parts by weight of carbon nanofiber, which is the same as that used in Example 1, were added and mixed based on 100 parts by weight of a polyurethane resin, thereby preparing a solution including a composition for shielding radiation.

A textile complex for shielding radiation was manufactured in the same manner as in Example 1, except that the solution including the composition for shielding radiation was coated to a thickness of 350 μm, instead of 150 μm, on a release film by means of a dam coater and an adhesive was coated to a thickness of 20 μm, instead of 50 μm.

### Example 3

100 parts by weight of a hardener (SVS-12,000-B manufactured by ShinEtsu), 10 parts by weight of a medium-density polyethylene powder, 5 parts by weight of a low-density polyethylene powder, and 5 parts by weight of a high-density polyethylene powder were mixed based on 100 parts by weight of a silicone resin (SVS-12,000-A manufactured by ShinEtsu).

Subsequently, 5 parts by weight of polyether ether ketone, which is the same as that of Example 1, was mixed therewith based on 100 parts by weight of the silicone resin, and 20 parts by weight of MEK and 30 parts by weight of toluene were additionally added based on 100 parts by weight of the silicone resin. As a result, a first preliminary composition was prepared.

Preliminary mixing was performed by adding 4 parts by weight of a molybdenum powder and 10 parts by weight of a tantalum powder, as metal powders, 60 parts by weight of tungsten oxide (WO₃) powder, as a metal oxide powder, and 10 parts by weight of barium sulfate (BaSO₄), as an inorganic additive, to the first preliminary composition.

Subsequently, 5 parts by weight of paraffin, 8 parts by weight of boron carbide (B₄C), and 10 parts by weight of carbon nanofiber which is the same as that of Example 1 were added and mixed based on 100 parts by weight of the silicone resin, as a main material. As a result, a solution including a composition for shielding radiation was prepared.

The solution including the composition for shielding radiation was coated to a thickness of 100 μm on a release film (or release paper) by means of a dam coater, thereby manufacturing a film for shielding radiation. Subsequently, drying was performed at 110° C. for 40 seconds such that a surface of the film was become a semi-dry state, and, in this state, woven fabric including polyester fiber was immediately laminated, followed by drying and hardening at 130° C. for 50 seconds. As a result, a textile complex for shielding radiation was manufactured.

### Example 4

10 parts by weight of a medium-density polyethylene powder 5 parts by weight of, a low-density polyethylene powder, and 5 parts by weight of a high-density polyethylene powder were mixed based on 100 parts by weight of an acrylic resin (manufactured by Hyup-Jin Chem. Industrial Co., Ltd.).

Subsequently, 20 parts by weight of polyether ether ketone, which is the same as that of Example 1, was mixed therewith based on 100 parts by weight of the acrylic resin, and 10 parts by weight of MEK and 15 parts by weight of toluene were additionally added based on 100 parts by weight of the acrylic resin, as a main material. As a result, a first preliminary composition was prepared.

Preliminary mixing was performed by adding 10 parts by weight of a molybdenum powder and 5 parts by weight of a tantalum powder, as metal powders, 40 parts by weight of tungsten oxide (WO₃) powder, as a metal oxide powder, and 20 parts by weight of barium sulfate (BaSO₄), as an inorganic additive, to the first preliminary composition.

Subsequently, 15 parts by weight of paraffin, 12 parts by weight of boron carbide (B₄C), and 7 parts by weight of carbon nanofiber which is the same as that of Example 1 were added and mixed based on 100 parts by weight of the acrylic resin. As a result, a solution including a composition for shielding radiation was prepared.

The solution including the composition for shielding radiation was coated to a thickness of 80 μm on a release film (or release paper) by means of a dam coater, thereby manufacturing a film for shielding radiation. Subsequently, an adhesive was prepared by mixing 100 parts by weight of a polyurethane adhesive resin, 10 parts by weight of a hardener, 20 parts by weight of DMF, and 20 parts by weight of MEK. A resultant adhesive was coated to a thickness of 300 μm by means of a comma knife. Woven fabric including polyester fiber was laminated on the adhesive and drying and hardening were performed at 130° C. for 50 seconds. As a result, a textile complex for shielding radiation was manufactured.

### Comparative Example 1

A textile complex for shielding radiation was manufactured under the same conditions as Example 1, except that a polyurethane resin was used alone instead of the first preliminary composition.

### Comparative Example 2

A textile complex for shielding radiation was manufactured by the same method and under the same conditions as Example 1, except that paraffin and carbon nanofiber were not used.

### Comparative Example 3

A textile complex for shielding radiation was manufactured by the same method and under the same conditions as Example 1, except that 35 parts by weight of tungsten oxide, as a metal component, was used alone instead of 4 parts by weight of a molybdenum powder and 3 parts by weight of a tantalum powder, as metal powders, 35 parts by weight of tungsten oxide (WO₃) powder, as a metal oxide powder, and 5 parts by weight of barium sulfate (BaSO₄), as an inorganic additive.

### Experimental Examples

### Experimental Example 1

### Evaluation of Radiation-Shielding Performance

The textile complex for shielding radiation manufactured according to each of Examples 1 to 4 and Comparative Examples 1 to 3 was subjected to a radiation-shielding experiment in a linear accelerator laboratory.

In particular, the textile complex for shielding radiation manufactured according to each of Examples 1 to 4, and Comparative Examples 1 to 3 was cut to a size of 50×50 cm, and then a radiation-shielding rate was measured 10 times while varying a measurement position according to radioactive sources and average energy values in summarized Tables 1 and 2 below. Subsequently, average values and change rates were measured and summarized in Tables 1 and 2 below.

The change rate is calculated by Equation 1 below.

Change rate (%)=Measured maximum radiation-shielding rate−Measured minimum radiation-shielding rate [Equation 1]

TABLE 1

| | | | | Shielding rate (%) | | | | | | |
|---|---|---|---|---|---|---|---|---|---|---|
| Radiation | Radioactive | Average | | | | | | Comparative | Comparative | Comparative |
| type | Source | energy | | Example 1 | Example 2 | Example 3 | Example 4 | Example 1 | Example 2 | Example 3 |
| Alpha | Po-210 | 5,300 | KeV | 100 | 100 | 100 | 100 | 100 | 100 | 100 |
| rays | | | | | | | | | | |
| Beta | Sr-90 | 69 | KeV | 92 | 98 | 92 | 95 | 75 | 71 | 74 |
| rays | Ti-204 | 72.4 | KeV | 98 | 95 | 90 | 92 | 88 | 74 | 77 |
| Gamma | Am- | 60 | KeV | 94 | 98 | 92 | 90 | 82 | 78 | 75 |
| rays | 241 | | | | | | | | | |
| | Co-57 | 122 | KeV | 88 | 92 | 88 | 85 | 76 | 72 | 66 |
| | Cs-137 | 661.7 | KeV | 78 | 83 | 85 | 81 | 64 | 67 | 48 |
| X- | Braking | 40 | kV | 100 | 100 | 100 | 100 | 96 | 95 | 86 |
| rays | radiation | 60 | kV | 98 | 98 | 96 | 95 | 93 | 90 | 80 |
| | | 80 | kV | 98 | 96 | 92 | 93 | 90 | 84 | 76 |
| | | 100 | kV | 96 | 93 | 91 | 92 | 87 | 77 | 73 |
| | | 120 | kV | 92 | 92 | 90 | 90 | 78 | 65 | 63 |

TABLE 2

| | | | | Change rate (%) | | | | | | |
|---|---|---|---|---|---|---|---|---|---|---|
| Radiation | Radioactive | Average | | | | | | Comparative | Comparative | Comparative |
| type | Source | energy | | Example 1 | Example 2 | Example 3 | Example 4 | Example 1 | Example 2 | Example 3 |
| Alpha | Po-210 | 5,300 | KeV | 0 | 0 | 0 | 0 | 0 | 0 | 0 |
| rays | | | | | | | | | | |
| Beta | Sr-90 | 69 | KeV | 2 | 2 | 3 | 3 | 25 | 27 | 23 |
| rays | Ti-204 | 72.4 | KeV | 4 | 4 | 6 | 5 | 19 | 20 | 22 |
| Gamma | Am-241 | 60 | KeV | 3 | 2 | 3 | 4 | 17 | 21 | 24 |
| rays | Co-57 | 122 | KeV | 5 | 4 | 6 | 7 | 23 | 24 | 26 |
| | Cs-137 | 661.7 | KeV | 7 | 6 | 8 | 10 | 28 | 28 | 31 |
| X- | Braking | 40 | kV | 0 | 0 | 0 | 0 | 20 | 19 | 22 |
| rays | radiation | 60 | kV | 2 | 2 | 3 | 5 | 22 | 22 | 24 |
| | | 80 | kV | 4 | 2 | 5 | 3 | 23 | 25 | 28 |
| | | 100 | kV | 7 | 6 | 9 | 8 | 26 | 29 | 31 |
| | | 120 | kV | 7 | 8 | 9 | 10 | 30 | 32 | 34 |

As shown in Tables 1 and 2, the fibers for shielding radiation according to Comparative Examples 1 to 3 exhibit low shielding rates against radiation, except for alpha rays, and high change rates, compared to the textile complexes for shielding radiation according to Examples 1 to 4.

Therefore, it can be confirmed that the textile complexes for shielding radiation according to Examples 1 to 4 of the present invention have excellent shielding effect against radiation such as beta rays, gamma rays, and X-rays.

### Experimental Example 2

### Evaluation of Neutron Ray Shielding Performance

The textile complex for shielding radiation manufactured according to each of Examples 1 to 4, and Comparative Examples 1 to 3 was subjected to neutron ray shielding performance evaluation. Results are summarized in Table 3 below.

An exit of neutron ray beams was manufactured in a predetermined size, and the intensity of neutron rays was calculated as a thermal neutron ray absorption cross section coefficient using a ratio of the number of incident neutron rays to the number of neutron rays passing through the textile complex for shielding radiation, after disposing a detector for measuring to be a predetermined distance (5 cm) away from the exit.

The neutron ray absorption cross section coefficient was calculated according to Equation 2 below.

I/I0=L−μ or μ=[log(I0/I)] [Equation 2]

(IO: incident beam, I: Transmission beam, L: scattering cross section coefficient, and μ: absorption cross section coefficient)

TABLE 3

| | | | | | Comparative | Comparative | Comparative |
|---|---|---|---|---|---|---|---|
| | Example 1 | Example 2 | Example 3 | Example 4 | Example 1 | Example 2 | Example 3 |
| Thermal | 4.545 | 4.402 | 4.505 | 4.565 | 5.454 | 5.090 | 4.773 |
| neutron ray | | | | | | | |
| absorption | | | | | | | |
| cross section | | | | | | | |
| coefficient | | | | | | | |
| μ(cm⁻¹) | | | | | | | |

As shown in Table 3, it can be confirmed that, in Comparative Example 1 in a polyethylene based resin (second resin component) was not used, neutron ray shielding effect reduces by about 20%. In addition, it can be confirmed that, in Comparative Example 2 in which a single material was used as a material for shielding neutron rays, i.e., a boron compound was merely used and paraffin and carbon nanofiber were not used, radiation-shielding effect decreases by about 10%. Therefore, it can be confirmed that the textile complexes for shielding radiation of Examples 1 to 4, in which a polyethylene based resin was included and paraffin, a boron compound, and carbon nanofiber were used as materials for shielding neutron rays, exhibit superior shielding effect even against neutron rays.

Embodiments of the invention provide non-obvious advantages over the conventional art. For example, there is provided a sheet for shielding radiation and a textile complex for shielding radiation, which includes a composition for shielding radiation according to various embodiments of the invention, and protective clothing including the same include a PEEK resin without use of lead, and thus, may shield even neutron rays as well as radiation, such as alpha rays, beta rays, proton rays, gamma rays, and X-rays.

Terms used herein are provided to explain embodiments, not limiting the invention. Throughout this specification, the singular form includes the plural form unless the context clearly indicates otherwise. When terms “comprises” and/or “comprising” used herein do not preclude existence and addition of another component, step, operation and/or device, in addition to the above-mentioned component, step, operation and/or device.

Embodiments of the invention may suitably comprise, consist or consist essentially of the elements disclosed and may be practiced in the absence of an element not disclosed. According to at least one embodiment, it can be recognized by those skilled in the art that certain steps can be combined into a single step.

The terms and words used in the specification and claims should not be interpreted as being limited to typical meanings or dictionary definitions, but should be interpreted as having meanings and concepts relevant to the technical scope of the invention based on the rule according to which an inventor can appropriately define the concept of the term to describe the best method he or she knows for carrying out the invention.

The singular forms “a,” “an,” and “the” include plural referents, unless the context clearly dictates otherwise.

As used herein and in the appended claims, the words “comprise,” “has,” and “include” and all grammatical variations thereof are each intended to have an open, non-limiting meaning that does not exclude additional elements or steps.

Occurrences of the phrase “according to an embodiment” herein do not necessarily all refer to the same embodiment.

Therefore, the embodiments disclosed herein are not intended to limit the present invention but to describe the embodiments of the invention, and the embodiments will not limit the spirit and scope of the embodiments of the invention. The scope of the embodiments of the invention should be interpreted from the appended claims, and all techniques within the range of equivalency should be interpreted as being included in the scope of the embodiments of the invention.

1. A composition for shielding radiation,comprising:
100 parts by weight of a first resin comprising one or more selected from the group consisting of a polyurethane resin, a polysiloxane resin, a silicone resin, a fluorine resin, an acrylic resin, and an alkyd resin;
5 to 30 parts by weight of a second resin comprising one or more selected from the group consisting of polyvinyl alcohol (PVA), medium-density polyethylene (MDPE), high-density polyethylene (HDPE), and low-density polyethylene (LDPE);
5 to 30 parts by weight of a polyether ether ketone (PEEK) resin powder;
5 to 80 parts by weight of a metal powder;
1 to 70 parts by weight of a metal oxide powder;
1 to 50 parts by weight of paraffin;
5 to 15 parts by weight of a boron compound; and
10 to 50 parts by weight of a carbon powder.

2. The composition according to claim 1, wherein the composition for shielding radiation further comprises 1 to 80 parts by weight of an inorganic additive based on 100 parts by weight of the first resin.

3. The composition according to claim 1, wherein the first resin is a polyurethane resin.

4. The composition according to claim 1, wherein the metal powder comprises one or more selected from the group consisting of aluminum, titanium, zirconium, scandium, yttrium, cobalt, tantalum, molybdenum, and tungsten.

5. The composition according to claim 1, wherein the metal oxide powder comprises one or more selected from the group consisting of palladium oxide, iridium oxide, ruthenium oxide, osmium oxide, rhodium oxide, platinum oxide, iron oxide, nickel oxide, cobalt oxide, indium oxide, aluminum oxide, potassium oxide, titanium oxide, tungsten oxide, and magnesium oxide.

6. The composition according to claim 2, wherein the inorganic additive comprises one or more selected from the group consisting of calcium hydroxide, calcium carbonate, magnesium hydroxide, magnesium carbonate, barium chloride, and barium sulfate.

7. The composition according to claim 1, wherein the boron compound comprises one or more selected from the group consisting of boric acid colemanite, zinc borate, boron carbide, boron nitride, and boron oxide.

8. The composition according to claim 1, wherein the carbon powder comprises one or more selected from the group consisting of fullerene, carbon nanofiber, and a carbon nanotube.

9. The composition according to claim 1, wherein the composition for shielding radiation further comprises 10 to 100 parts by weight of a hardener based on 100 parts by weight of the first resin.

10. A sheet for shielding radiation, comprising the composition for shielding radiation according to claim 1.

11. A textile complex for shielding radiation, comprising:
a textile; and
the sheet for shielding radiation according to claim 9 formed on the textile.

12. The textile complex according to claim 11, wherein the textile comprises any one of woven fabrics, knitted fabrics, and non-woven fabrics.

13. The textile complex according to claim 11, wherein the textile comprises any one selected from among polyester fiber, nylon fiber, and aramid fiber.

14. The textile complex according to claim. 11, wherein the textile complex for shielding radiation further comprises an adhesive layer between the textile and the sheet for shielding radiation,

15. The textile complex according to claim 11, wherein the textile complex for shielding radiation is used in one or more of a bag, protective equipment, and protective clothing for shielding radiation.

16. A textile complex for shielding radiation, comprising a laminate manufactured by sequentially laminating a first textile;
a first adhesive layer disposed on the first textile;
a sheet for shielding radiation disposed on the first adhesive layer;
a second adhesive layer disposed on the sheet for shielding radiation; and
a second textile disposed on the second adhesive layer.

17. A method of manufacturing a textile complex for shielding radiation, the method comprising:
a step of coating an interior of a side dam, which comprises a release paper on a bottom surface thereof, with the composition for shielding radiation prepared according to claim 1 (step 1);
a step of preparing a sheet for shielding radiation by drying the composition coated according to step 1 (step 2); and
a step of manufacturing a textile complex for shielding radiation by attaching a textile to the sheet for shielding radiation (step 3).
